(19) United States
(12) Patent Application Publication
(10) Pub. No.: US 2001/0050694 A1
(43) Pub. Date: Dec. 13, 2001

(54) Time recorder

(75) Inventors: Kozo Iwaki, Tokyo (JP); Hiroaki Suto, Tokyo (JP)

Correspondence Address: MORGAN, LEWIS & BOCKIUS, 1800 M STREET NW, WASHINGTON, DC, 20036-5869, US

(73) Assignee: MAX CO., LTD.

(21) Appl. No.: 09/878,285

(22) Filed: Jun. 12, 2001

(30) Foreign Application Priority Data
Jun. 13, 2000 (JP) 2000-177623
Jun. 19, 2000 (JP) 2000-183652
Aug. 22, 2000 (JP) 2000-250734

(51) Int. Cl. G01D 9/00

(52) U.S. Cl. 346/20; 455/344

(57) ABSTRACT

A time recorder includes a radio wave clock having a receiving controller for regularly executing a receiving operation of a standard time wave. The radio wave clock automatically corrects the current time based on the time data of the standard time wave on successful reception of the standard time wave. The time recorder further includes: a storing device for storing the time of successful reception of the standard time wave; and a receiving schedule setting device that assumes the time zone around the successful receiving time as the next receiving trial time zone. Preferably, the time recorder includes: a receiving operation indicator for indicating the receiving operation of the standard time wave; an input level indicator for indicating reception of the standard time wave during the receiving operation; and a controller for varying the blinking interval of said input level indicator depending on the input level.

### BACKGROUND OF THE INVENTION

1. Field of the Invention

The present invention relates to a time recorder, and in particular to a time recorder where the error of the clock is automatically corrected.

2. Description of the Related Art

In a conventional electronic time recorder, a built-in clock cannot avoid a certain degree of error. It is thus necessary to check and correct the error of the clock on a routine basis.

### SUMMARY OF THE INVENTION

The above leads to technical problems to be solved in order to save the work of clock management of a time recorder and reduce the management effort. The invention aims at solving the problems.

The invention, proposed to attain the objects, provides a time recorder incorporating a radio wave clock including a receiving controller for regularly executing receiving operation of a standard time wave, the clock automatically correcting the current time based on the time data of the standard time wave on successful reception of the standard time wave, wherein the time recorder comprises means for storing the time of successful reception of the standard time wave and receiving schedule setting means that assumes the time zone around the successful receiving time as the next receiving trial time zone.

Further, the invention provides a time recorder incorporating a radio wave clock including a receiving controller for regularly executing receiving operation of a standard time wave, the clock automatically correcting the current time based on the time data of the standard time wave on successful reception of the standard time wave,

wherein the time recorder includes a receiving operation indicator such as an LED or lamp to indicate the receiving operation during receiving operation and an input level indicator such as an LED or lamp to indicate reception of a radio wave during receiving operation, as well as control means for varying the blinking interval of the input level indicator depending on the input level.

Further, the invention provides a time recorder incorporating a radio wave clock including a receiving controller for regularly executing receiving operation of a standard time wave, the clock automatically correcting the current time based on the time data of the standard time wave on successful reception of the standard time wave,

wherein the time recorder includes receiving time setting means for arbitrarily setting the receiving operation time of the radio wave clock,

wherein the time recorder includes control means for inhibiting the radio wave receiving operation of the radio wave clock from the first printing time to the time when all attendants left an office in a day, and

wherein the time recorder includes control means for reading the earliest starting time data and the latest quitting time data from the past data stored in the time recorder and inhibiting the radio wave receiving operation of the radio wave clock between the earliest starting time and the latest quitting time.

### BRIEF DESCRIPTION OF THE DRAWINGS

FIG. 1 is a block diagram of a time recorder according to the first embodiment of the invention.

FIG. 2 is a flowchart of the automatic time calibration by the time recorder according to the first embodiment of the invention.

FIG. 3 is a block diagram of a time recorder according to the second embodiment of the invention.

FIG. 4 is a flowchart of the automatic time calibration by the time recorder according to the second embodiment of the invention.

FIG. 5 is a block diagram of a time recorder according to the third embodiment of the invention.

FIG. 6 is a flowchart of the automatic time calibration by the time recorder according to the third embodiment of the invention.

FIG. 7 is another flowchart of the automatic time calibration by the time recorder according to the third embodiment of the invention.

### DETAILED DESCRIPTION OF THE PREFERRED EMBODIMENTS

Embodiments of the invention will be detailed referring to drawings.

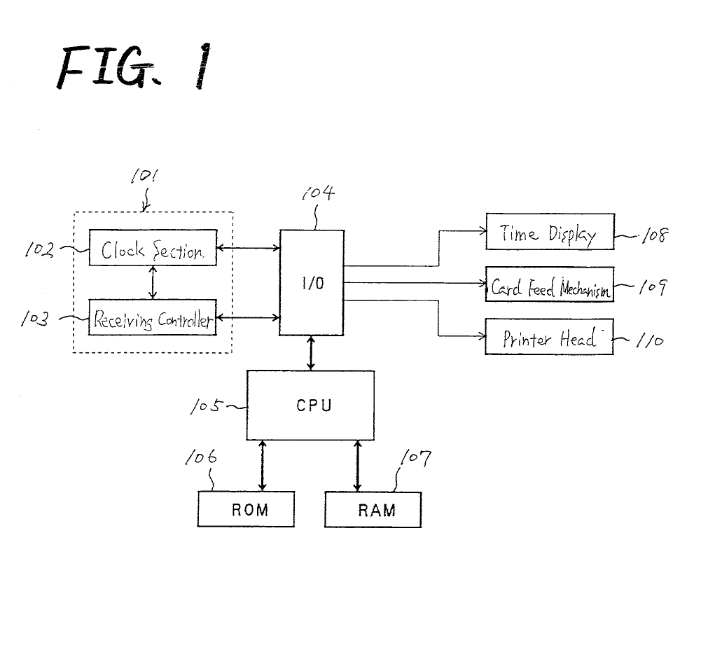

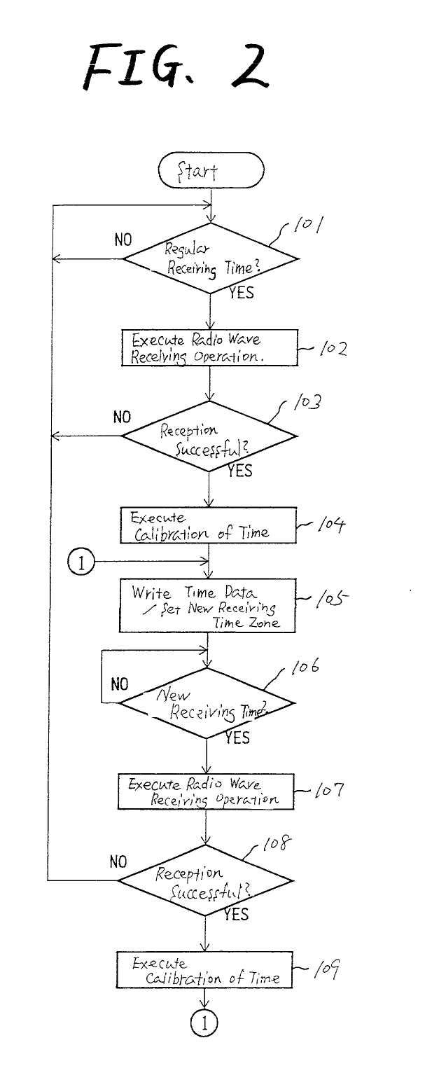

A first embodiment of the invention will be detailed referring to FIGS. 1 and 2. FIG. 1 is a block diagram of a time recorder according to the first embodiment of the invention. A radio wave clock 101 is composed of a clock section 102 and a receiving controller 103. A numeral 104 designates an I/O, 105 a CPU, 106 a ROM, and 107 a RAM.

The CPU 105 sequentially reads the time data of the clock section 102 of the radio wave clock 101 via the I/O 104 and drives a time display 108 to display time. When a time card is inserted into the card slot of the time recorder, the CPU 105 drives the card feed mechanism 109 to pull the time card and read the personal ID number of the time card as well as feeds the time card until the date column of the time card corresponding to the current date coincides with the position of the printer head 110 and prints the current time in the starting time column or the quitting time column.

The printed time data is written into and stored in the individual data tables in the RAM 107 and the administrator can read or print out the totalized duty hours data anytime, same as in a conventional time recorder.

The receiving controller 103 of the radio wave clock 101 is equipped with the function to receive the standard time wave and the function to correct the clock section 102. In case the power cord of the time recorder is not connected to a commercial power source or in case a commercial power source is not supplied due to power outage, the clock section 102 of the radio wave clock 101 feeds the power from the lithium battery to compensate for power outage built into the time recorder to operate the clock. In this case, the receiving operation other than the clock count is not executed in order to suppress the power consumption.

The ROM 106, same as a general radio wave clock, stores a regular receiving schedule program for executing the receiving operation of the standard time wave every hour and anew receiving schedule setting program for setting the receiving schedule anew at actual operation. The CPU 105 controls the radio wave clock based on the regular receiving schedule program and the new receiving schedule setting program.

When the power cord of the time recorder is connected to the AC outlet of the commercial power source, the time recorder enters the receiving mode at a fixed time according to the regular receiving schedule to try receiving of the standard time wave, and on successful reception of the standard time wave, calibrates the time data of the clock section 102 as well as sets the receiving schedule anew, and executes receiving operation in the next and the subsequent rounds.

FIG. 2 shows the flow of control of the radio wave clock. When the power cord of the time recorder is connected to the AC outlet, the time recorder is energized, and the CPU 105 reads the time data from the clock section 102 of the radio wave clock 101 then causes the receiving controller to execute receiving operation when the radio wave receiving time written in the regular receiving schedule program is reached (Steps 101 to 102). In case the receiving controller has failed to receive the time data, it executes the receiving operation again at the next regular receiving time (Steps 103 to 101)

When the receiving controller has succeeded in receiving the time data, it calibrates the time of the radio wave clock, and the CPU 105 writes the successful receiving time data into the RAM 107 based on the new schedule setting program and sets the time zone of a certain width around the time as a new receiving time zone (Steps 104 to 105).

The new receiving schedule setting program is adapted to execute receiving operation in the new receiving time zone that is based on the successful receiving time data (Steps 106->107->108->109), instead of returning to the receiving operation based on the regular receiving schedule program (Steps 101 to 102), once the successful receiving time data has been acquired. Since the sending power of the standard time wave transmitting station is weak, the wave clock hardly succeeds in receiving the radio wave from the station every time and the time zone where receiving of the radio wave is successful is somewhat limited, although not constant depending on the installation environment of the time recorder. Thus, by executing the receiving operation in the next and the subsequent rounds at the time which reception is successful, it is possible to omit the receiving operation in the time zones where reception of the radio wave is hardly successful thereby upgrading the work efficiency of the time recorder. The aforementioned setting program is based on this philosophy.

After obtaining the successful receiving time data, the receiving controller 103 starts receiving the standard time wave in the new receiving time zone. In case the receiving controller has succeeded in receiving the radio wave, it automatically calibrates the current time setting of the clock section 102 based on the obtained time data. In case the receiving controller fails to receive the radio wave in the first trial, it retries receiving of the standard time wave until it succeeds. In case the receiving controller fails to receive the radio wave in the new receiving time zone, execution returns to Step 101 after completion of receiving operation and executes the routine starting with Step 101 to perform the receiving operation via the regular receiving schedule program.

The calibration time at successful reception is displayed on the display board of the time recorder for checkup of calibration history. The calibration time may be printed on a time card.

As discussed above, by providing a function to regularly receiving the standard time wave (JJY), same as a radio wave clock, in the clock of a time recorder and automatically correct time can reduce the effort of clock management.

However, since the long-wave standard time wave has a small sending power, a time recorder positioned in a place where receiving radio wave is weak has lower possibility of successful reception of the standard time wave. The radio wave receiving condition varies with time, it is necessary to consider the installation place of the time recorder. Thus, information on the radio wave receiving state allows determination on whether the installation place is appropriate or not.

As indicator means of field strength of a receiving radio wave, an indicator of electric field strength in a bar-graph form via an LED panel or a plurality of aligned LEDs is generally known. However, such an indicator is disadvantageous in that it requires a considerable space on the display panel and that it is impossible to determine whether the receiving operation is suspended or electric field strength is too small while LEDs are off.

This leads to further technical problems to be solved in order to indicate the receiving operation and the electric field strength of the standard time wave thus providing a more practical time recorder with a built-in radio wave clock. A second embodiment of the invention aims at solving these problems.

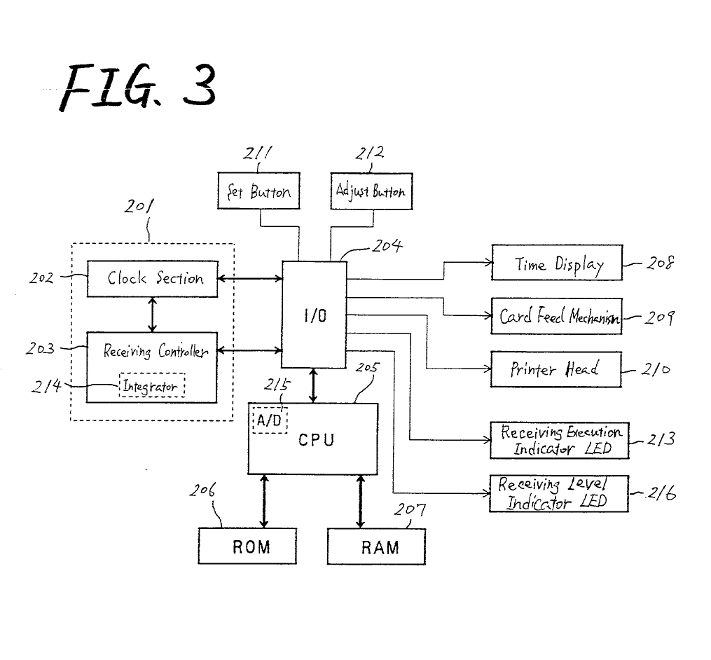

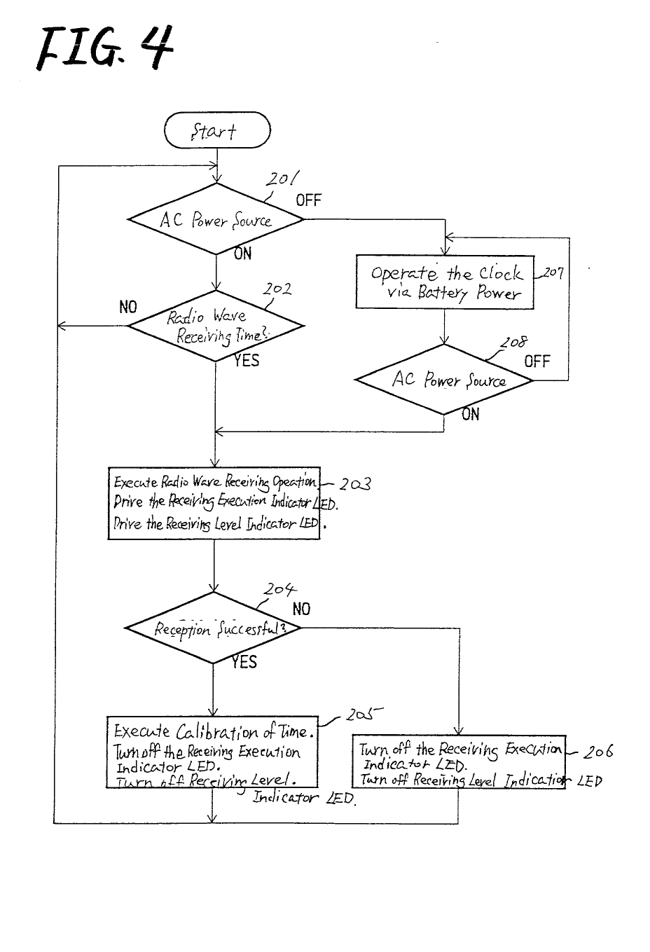

Hereinafter, the second embodiment of the invention will be detailed referring to FIGS. 3 and 4. FIG. 3 is a block diagram of a time recorder according to the second embodiment of the invention. A radio wave clock 201 is composed of a clock section 202 and a receiving controller 203. A numeral 204 designates an I/O, 205 a CPU, 206 a ROM, and 207 a RAM.

The CPU 205 sequentially reads the time data of the clock section 202 of the radio wave clock 201 via the I/O 204 and drives a time display 208 to display time. When a time card is inserted into the card slot of the time recorder, the CPU 205 drives the card feed mechanism 209 to pull the time card and read the personal ID number of the time card as well as feeds the time card until the date column of the time card corresponding to the current date coincides with the position of the printer head 210 and prints the current time in the starting time column or the quitting time column.

The printed time data is written into and stored in the individual data tables in the RAM 207 and the administrator can read or print out the totalized duty hours data anytime, same as in a conventional time recorder.

The receiving controller 203 of the radio wave clock 201 is equipped with the function to receive the standard time wave and the function to correct the clock section 202. A set button 211 is used to select the date/time display mode or the date/time correction mode and the adjust button 212 is used to set the current time.

The ROM 206 stores a regular receiving schedule program for executing the receiving operation of the standard time wave every hour. The CPU 205 controls the radio wave clock 201 based on the regular receiving schedule program and causes the receiving execution indicator LED 213 to illuminate during receiving operation in order to show that receiving operation is in progress.

In the second stage of an RF amplifier stage of the receiving controller 203 is provided an integrator 214. The output of the integrator 214 is input to an A/D converter 215. The CPU 205 detects the level of the radio wave input from an antenna (not shown) and drives the receiving level indicator LED 216 depending on the input level.

The receiving level indicator LED 216 does not illuminates while the antenna input level is zero but permanently illuminates at a level where time data may be read. Via a configuration where the LED 216 blinks while the antenna input level is between zero and the time data readable level the speed of blinking is varied depending on the input level, it is possible to determine the degree of the antenna input level.

FIG. 3 shows the flow of control of the radio wave clock. The radio clock is driven by a power outage compensation battery until the power cord of the time recorder is connected to an AC outlet (Steps 201->207->208->207).

When the power cord is connected to the AC outlet, a receiving operation execution instruction is output to the receiving controller 203 of the radio wave clock 201. This causes the receiving controller 3 to start receiving the standard time wave (Steps 208->203) and the receiving execution indicator LED 213 to illuminate as well as causes the receiving level indicator LED 216 to blink or illuminate depending on the antenna input level.

While the receiving level indicator LED 216 does not illuminate or blink at a lower speed, the antenna input level is zero or low thus automatic calibration of the time cannot be expected. In this case, it is necessary to move the time recorder to a location where the receiving level LED 216 illuminates or blinks at a high speed.

When the receiving controller has succeeded in receiving the standard time wave, it calibrates the current time setting of the clock section 202, and stops the receiving operation. This turns off the receiving execution indicator LED 213 and the receiving level indicator 216 (Steps 204->205).

In case the receiving controller has failed to receive the standard time wave in the first trial, it retries receiving of the standard time wave. In case receiving controller has failed to receive the standard time wave in a predetermined number of trials, it stops the receiving operation. This turns off the receiving execution indicator LED 13 and the receiving level indicator 16 (Step 206).

When a predetermined radio wave receiving time is reached, the receiving controller repeats the routine to try automatic calibration of time setting on a regular basis.

When a power outage has taken place, the clock is driven by a built-in battery (Steps 201->207->208->207). When the power is restored, the CPU 5 detects the restoration of power and causes the receiving controller 3 to execute radio wave receiving operation (Steps 208->203).

As discussed in the first and second embodiments of the invention, effort of time management can be reduced by incorporating a radio wave clock having an automatic time correction function in a time recorder. However, using a radio wave clock that typically performs a single receiving operation per hour places the time recorder in the receiving state in duty hours on a regular basis. In case the time of the clock is corrected during the duty hours, the actual duty hours may differ from the duty hours data on the time recorder.

This leads to further technical problems to be solved in order to eliminate the effort of time management and avoid any difference between the actual duty hours and the working hours on the time recorder. A third embodiment of the invention aims at solving these problems.

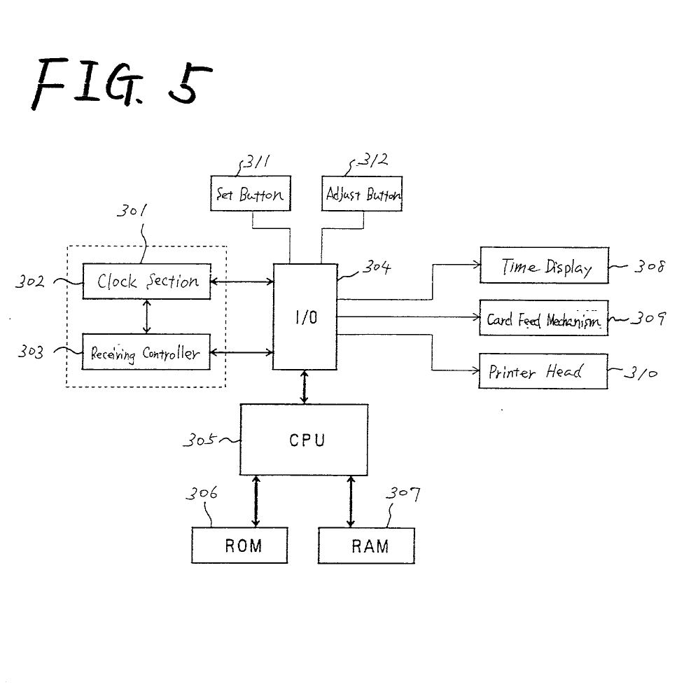

Hereinafter, the third embodiment of the invention will be detailed referring to FIGS. 5 to 7. FIG. 5 is a block diagram of a time recorder according to the invention. A radio wave clock 301 is composed of a clock section 302 and a receiving controller 303. A numeral 304 designates an I/O, 305 a CPU, 306 a ROM, and 307 a RAM.

The CPU 305 sequentially reads the time data of the clock section 302 of the radio wave clock 301 via the I/O 304 and drives a time display 308 to display time. When a time card is inserted into the card slot of the time recorder, the CPU 305 drives the card feed mechanism 309 to pull the time card and read the personal ID number of the time card as well as feeds the time card until the date column of the time card corresponding to the current date coincides with the position of the printer head 310 and prints the current time in the starting time column or the quitting time column.

The printed time data is written into and stored in the individual data tables in the RAM 307 and the administrator can read or print out the totalized duty hours data anytime, same as in a conventional time recorder.

The receiving controller 303 of the radio wave clock 301 is equipped with the function to receive the standard time wave and the function to correct the clock section 302. A set button 311 is used to select the date/time display mode or the date/time correction mode and the adjust button 312 is used to set the current time and the receiving time.

The ROM 306 stores a regular receiving schedule program for executing the receiving operation of the standard time wave every hour, same as a general radio wave clock, and a program executing reception at an arbitrarily set time. The CPU 305 controls the radio wave clock 301 based on the regular receiving schedule program or arbitrary receiving execution program.

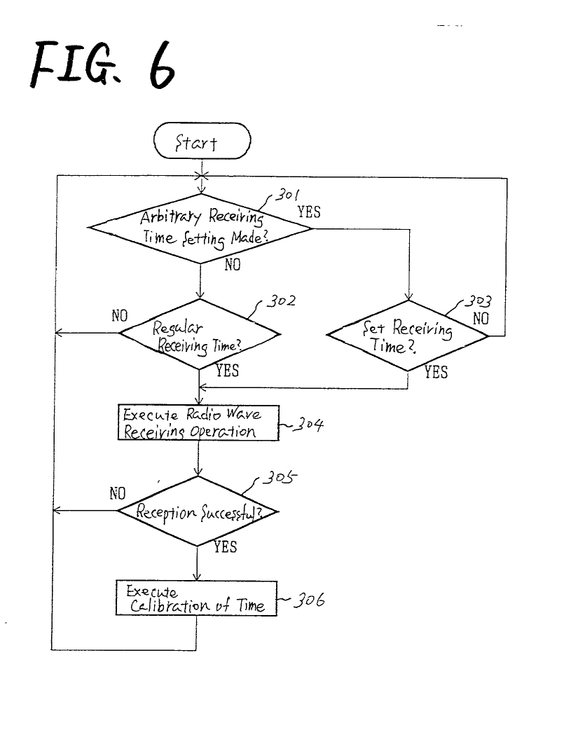

FIG. 6 shows the flow of control of the radio wave clock. When the power cord of the time recorder is connected to the AC outlet, the time recorder is energized, and the CPU 305 reads the time data from the clock section 302 of the radio wave clock 301.

In case the receiving time is not set manually, the receiving controller enters the receiving mode and tries receiving the standard time wave on a regular basis or once an hour (Steps 301->302->304). In case the receiving controller has failed to receive the standard time wave, it retries receiving the standard time wave at the next receiving time (Steps 305->301). In case the receiving controller has succeeded in receiving the standard time wave, it calibrates the time of the radio wave clock (Step 306) and execution returns to Step 1.

In case the receiving time is set manually, execution follows from Step 301 to Step 303. The receiving controller enters the receiving mode at a specified time (Step 304) and tries receiving the standard time wave. Thus, in case setting of receiving time is manually made to the midnight or early in the morning, the radio wave clock never starts receiving operation during duty hours, and the time of the radio wave clock is not corrected during duty hours. Accordingly, there arises no difference between the actual duty hours and the duty hours data on the time recorder.

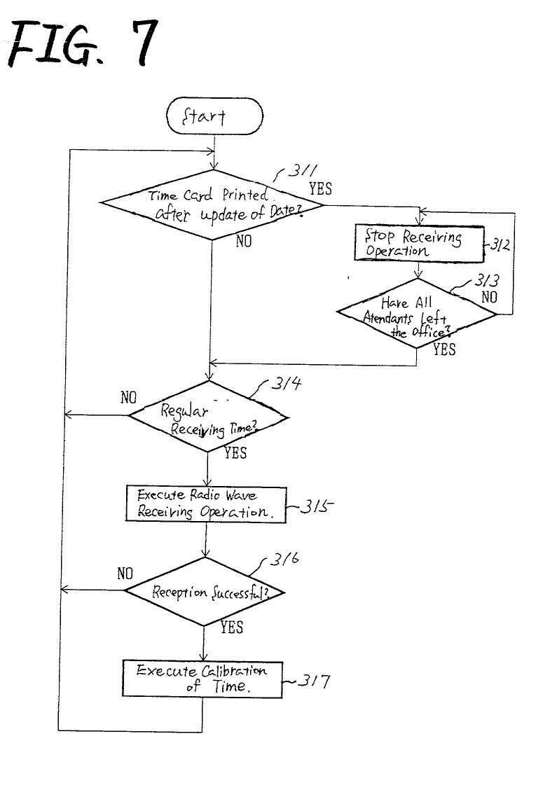

FIG. 7 shows another example of the radio wave control of the third embodiment of the invention. In this embodiment, the receiving controller is automatically placed in the receive operation halt mode during duty hours. From the update of date (not necessarily 12:00 midnight but set depending on the duty schedule) to the first printing on a time card on the day, the receiving controller enters the receiving mode on a regular basis (once an hour) according to the ordinary regular receiving schedule program and tries receiving the standard time wave (Steps 311->314->315). In case the receiving controller has failed to receive the standard time wave, it retries the receiving operation at the next regular receiving time (Steps 316->311). In case the receiving controller has succeeded in receiving the standard time wave, it calibrates the time of the radio wave clock (Step 317) and execution returns to Step 311.

When the first time card on the day is inserted into the time recorder and is printed, execution proceeds from Steps 311 to 312 and receiving operation is stopped. The receiving operation continues until quitting times are printed on all the time cards on which starting times are printed on the day (known from the attendance data in RAM 307), that is, until all the attendants on that day leaves the office. Once all the attendants have left the office, execution proceeds from Steps 313 to 314 and the receiving controller enters the regular receiving mode (Step 314) and tries receiving the standard time wave until the first time card on the next data is inserted into the time recorder.

Thus, same as the control of the radio wave clock in FIG. 6, the radio wave clock never starts the receiving operation and the time of the radio wave clock is corrected off duty hours. Accordingly, there arises no difference between the actual duty hours and the duty hours data on the time recorder.

Another embodiment that is not shown is possible where the receiving schedule is configured so that the CPU 305 may read the earliest starting time data and the latest quitting time data from the past starting time data stored in the RAM 307 of the time recorder and that the receiving controller may be automatically placed in the regular receiving mode only between the latest quitting time and the earliest starting time.

The calibration time at successful reception is displayed on the display board of the time recorder for checkup of calibration history. The calibration time may be printed on a time card.

While only certain embodiments of the invention have been specifically described herein, it will be apparent that numerous modifications may be made thereto without departing from the spirit and scope of the invention.

As discussed above, a time recorder according to the first embodiment of the invention incorporates a radio wave clock and automatically calibrates the time of the clock based on the standard time wave. Thus it is possible to prevent an error in the duty hours data caused by an error of the clock. It is also possible to execute the receiving operation of the standard time wave intensively in a time zone where reception of the radio wave is generally successful, thus eliminating the effort of repeating receiving operation in the time zones where reception of the radio wave is hardly successful and reducing the power consumption.

Further, a time recorder according to the second embodiment of the invention incorporates a radio wave clock and automatically calibrates the time of the clock based on the standard time wave. Thus it is possible to eliminate the effort of clock management. The receiving operation indicator illuminates and the input level indicator blinks or illuminates to indicate the input level of the receiving radio wave during receiving operation. Thus it is made easy to determine the radio wave receiving condition during receiving operation by checking the receiving operation indicator and the input level indicator and select an installation place with favorable receiving level.

The receiving operation indicator and the input level indicator can be configured by a single LED respectively. This is advantageous in that such an indicator leaves space on the front panel or time display panel on the time recorder.

Moreover, a time recorder according to the third embodiment of the invention incorporates a radio wave clock and automatically calibrates the time of the clock based on the standard time wave. Thus it is possible to prevent an error in the starting/quitting time data caused by an error of the clock. Correction of time is not executed during duty hours, thus reduce the effort of clock management of the time recorder.

What is claimed is:

1. A time recorder comprising:
a radio wave clock including a receiving controller for regularly executing a receiving operation of a standard time wave, said radio wave clock automatically correcting the current time based on the time data of the standard time wave on successful reception of the standard time wave;
a storing device for storing time of successful reception of the standard time wave; and
a receiving schedule setting device that assumes a time zone around the time of successful reception as the next receiving trial time zone.

2. A time recorder comprising:
a radio wave clock including a receiving controller for regularly executing a receiving operation of a standard time wave, said radio wave clock automatically correcting the current time based on the time data of the standard time wave on successful reception of the standard time wave;
a receiving operation indicator for indicating the receiving operation of the standard time wave;
an input level indicator for indicating reception of the standard time wave during the receiving operation; and
a controller for varying the blinking interval of said input level indicator with depending on the input level.

3. The time recorder according to claim 2,
wherein said receiving operation indicator includes one of an LED and a lamp for indicating the receiving operation.

4. The time recorder according to claim 2,
wherein said input level indicator includes one of an LED and a lamp for indicating reception of the standard time wave.

5. A time recorder comprising:
a radio wave clock including a receiving controller for regularly executing a receiving operation of a standard time wave, said radio wave clock automatically correcting the current time based on the time data of the standard time wave on successful reception of the standard time wave; and
a receiving time setting device for arbitrarily setting a time for executing the receiving operation of said radio wave clock.

6. A time recorder comprising:
a radio wave clock including a receiving controller for regularly executing a receiving operation of a standard time wave, said radio wave clock automatically correcting the current time based on the time data of the standard time wave on successful reception of the standard time wave; and
a controller for inhibiting the receiving operation of said radio wave clock from a first time when the first attendant to enter is recorded to a second time when the last attendant to leave is recorded.

7. A time recorder comprising:
a radio wave clock including a receiving controller for regularly executing a receiving operation of a standard time wave, said radio wave clock automatically correcting the current time based on the time data of the standard time wave on successful reception of the standard time wave;
a controller for reading the earliest starting time data and the latest quitting time data from past data of starting time and quitting time, the past data stored in said time recorder, and for inhibiting the receiving operation of said radio wave clock between the earliest starting time and the latest quitting time.
